(19) United States
(12) Patent Application Publication
(10) Pub. No.: US 2026/0244616 A1
(43) Pub. Date: Aug. 20, 2026

(54) EXPLANATIONS OF DATABASE QUERY RESULTS BY A VIRTUAL ASSISTANT

(71) Applicant: Adobe Inc., San Jose, CA (US)

(72) Inventors: Soumyabrata Pal, Bengaluru (IN); Ramasuri Narayanam, Bangalore (IN); Kun Qian, Sammamish, WA (US); Shiv Kumar Saini, Bangalore (IN); Yunyao Li, San Jose, CA (US)

(73) Assignee: Adobe Inc., San Jose, CA (US)

(21) Appl. No.: 19/059,059

(22) Filed: Feb. 20, 2025

(51) Int. Cl. G06F 16/242; G06F 16/248

(52) U.S. Cl. CPC G06F 16/243; G06F 16/248

(57) ABSTRACT

Techniques and systems for explanations of database query results by a virtual assistant are described. In an example, a processing device is operable to receive an input that includes a request in a natural language format related to a database. For example, the request is an instruction to create, alter, retrieve, delete, manage, or manipulate the database or data in the database. A first machine-learning model (e.g., a large language model (LLM)) generates a database query based on the request. The processing device queries the database using the database query to obtain a query result. A second machine-learning model generates a query explanation of the database query in the natural language format. The processing device then presents the query result and query explanation in a user interface.

### BACKGROUND

Software providers increasingly integrate artificial intelligence (AI) assistants to enhance user experience by offering quick access to information and resources related to their software applications. For example, database providers often implement a natural language interface powered by an AI assistant, enabling users to pose questions as natural language queries (NLQs). The AI assistant interprets the NQLs and translates them into structured query language (SQL) commands to be executed on the database.

Once the query is processed, the AI assistant retrieves the relevant data and presents the results to the user. However, users often do not receive context for the data presented. The lack of context leaves users feeling uncertain about the accuracy of the query execution and whether the AI assistant interpreted their original question correctly. Alternatively, users incorrectly assume their question was properly interpreted and act on incorrect data.

### SUMMARY

Techniques for generating explanations of database query results using artificial intelligence (AI) virtual assistance are described to enable greater user certainty in the accuracy of AI assistance with database queries. In an example, a virtual assistance module leverages a first large language model (LLM) to consider a user query, including the context, intent, or sentiment associated with the user query, and generate a query. The user query is received as an NLQ and the first LLM generally converts the NLQ into a SQL query. The virtual assistance module then executes the SQL query in a database and obtains query results.

The virtual assistance module also uses a second LLM to generate query explanations for the SQL query in a natural language format. The query explanation is generated using the SQL query, but not the NLQ to avoid the original user request from biasing the second LLM. The query explanations include a short summary of the SQL query's intent, a step-by-step description of how the query results were obtained using the SQL query, and/or inline technical comments explaining the schema of the SQL query. The virtual assistance module then presents the query result and query explanations in a user interface. In this way, the virtual assistance module provides users with greater understanding and confidence in query results obtained using AI virtual assistants.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ an AI virtual assistant to provide explanations of database queries as described herein.

FIG. 2 depicts an example implementation of a virtual assistant module of FIG. 1 in greater detail as employing techniques to provide explanations of database queries as described herein.

FIG. 3 depicts an example implementation of an explanation module of FIG. 2 in greater detail as employing techniques to provide explanations of database queries.

FIGS. 4A and 4B illustrate an example query and explanations generated from a NLQ using an AI virtual assistant that provides explanations of database queries as described herein.

FIG. 5 is a flow diagram depicting an algorithm as a step-by-step procedure in an example implementation of operations performable for training a machine-learning model of the virtual assistant module of FIG. 1.

FIG. 6 is a flow diagram depicting a procedure in an example implementation for providing explanations of database queries by an AI virtual assistant as described herein.

FIG. 7 illustrates an example system that includes an example computing device that is representative of one or more computing systems and/or devices for implementing the various techniques described herein.

### DETAILED DESCRIPTION

### Overview

As described above, software providers frequently integrate AI assistants into their products to offer quick and easy access to database information. These AI assistants provide a natural language interface, allowing users to input questions and database queries using NLQs. The AI assistant processes these NQLs and translates them into SQL commands to interact with the database.

SQL commands use a standardized language to retrieve, insert, update, or delete data within a database. Additionally, SQL commands are used to create, alter, or drop tables, databases, and other objects. Although SQL commands are used for a wide range of tasks, from simple data retrieval to complex data analysis, SQL is a standardized language that uses specific language and complex schema to perform the requested operation.

Once the query is processed, conventional AI assistants retrieve the relevant data and present the results to the user. Such AI assistants empower users to leverage the analytical capabilities of relational databases without needing to be experts in SQL commands. These conventional AI assistants also enable users to retrieve database information quickly and efficiently.

Conventional AI assistants often fail to provide context for the data presented. This lack of context leaves users uncertain about the accuracy of the results and whether the AI assistant correctly interpreted their original question. While some conventional AI assistants share the corresponding SQL query with the data response or upon request, the technical nature of SQL commands makes it difficult for many users to verify if the correct data was returned.

For instance, if a user searches for a dataset named “Mutual365,” a conventional AI assistant returns no results because the SQL query uses an exact name search. This query overlooks datasets containing “Mutual365” within their names, leading to missed opportunities to retrieve relevant information.

To address these issues and provide customers with greater confidence in AI assistants that perform text-to-SQL searches, this document describes techniques and systems to explain database query results. The AI virtual assistant generates natural language explanations for the results retrieved from databases. In one implementation, the described techniques and systems provide a plain-language description of the intent behind the database query, a step-by-step account of how the results are obtained, and/or inline comments on the database query to enhance user understanding.

The input for a machine-learning model that generates these explanations is the database query created by the AI assistant. The user's question (e.g., NLQ) is not provided to the machine-learning model to prevent the generated explanations from being influenced by the intent of the NLQ. Since the query explanations are based on the database query (e.g., in SQL format), if the NLQ's intent aligns with the generated query's intent, users have greater confidence that the retrieved results correspond to their original question. Because both the NLQ and query intent are provided in natural or plain language, users are able to quickly compare the intents and proceed with the returned query results or submit an updated NLQ.

The described techniques utilize in-context learning to generate accurate descriptions of the query intent. To enable a better understanding of how to create a query intent from a provided SQL query, a few curated examples are appended to the prompt. The examples are chosen from an example bank that includes a number of (e.g., several hundred) example pairs with a SQL query and corresponding query intent (or other query explanations). The curated examples provided in the LLM prompt are dynamically chosen based on the user's NLQ and used by the LLM to guide and enhance the query explanations.

### TERM EXAMPLES

A “machine-learning model” refers to a computer representation that is tunable (e.g., trained and retrained) based on inputs to approximate unknown functions. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which often include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

The following discussion describes an example environment that employs the techniques described herein. Example procedures that are performable in the example environment and other environments are also described. Consequently, the performance of the example procedures is not limited to the example environment, and the example environment is not limited to the performance of the example procedures.

### Virtual Assistance Environment

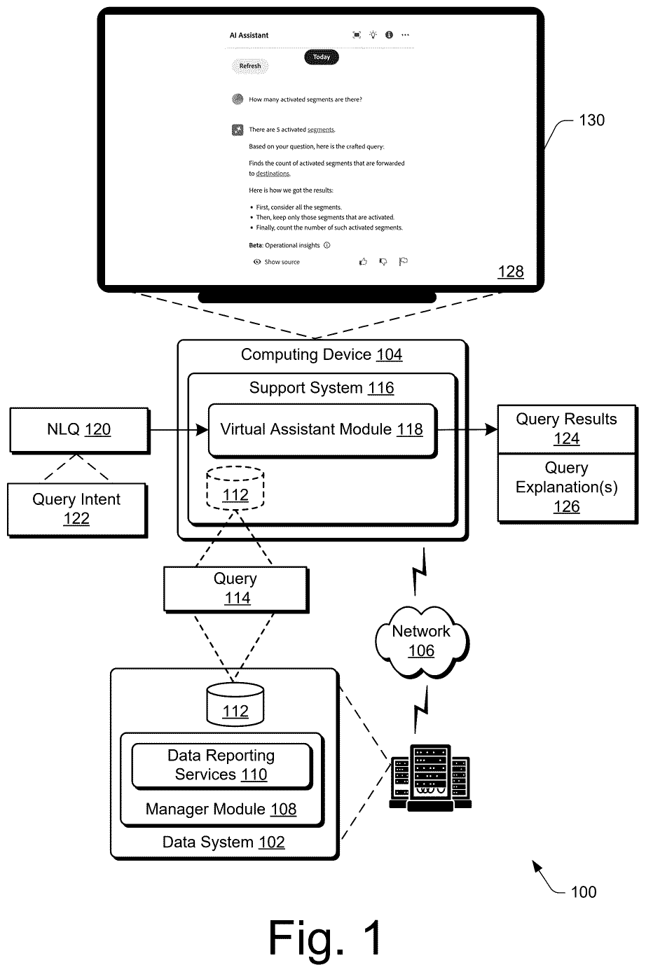

FIG. 1 illustrates environment 100 in an example implementation that is operable to employ an AI virtual assistant to provide explanations of database queries as described herein. The illustrated environment 100 includes a data system 102 and a computing device 104 that are communicatively coupled, one to another, via a network 106.

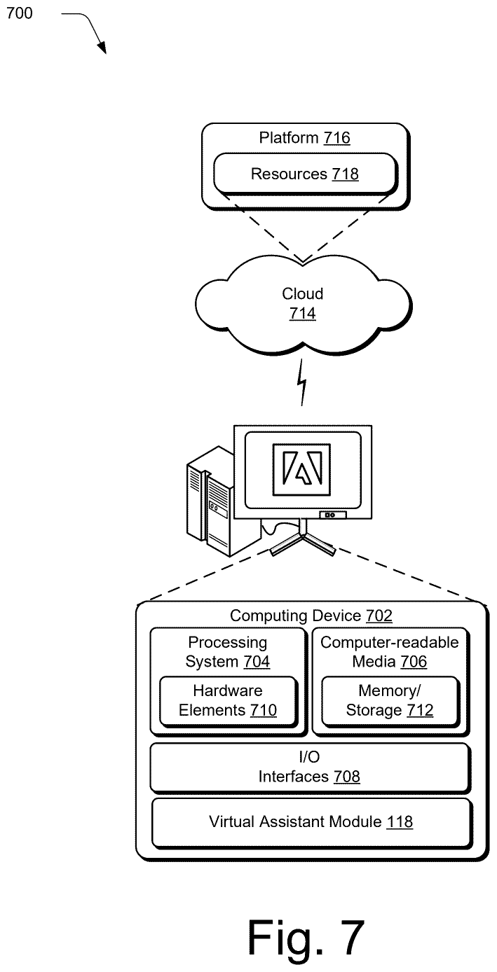

The data system 102 and the computing device 104 are examples of computing systems configurable in various ways. A computing system, for instance, is configurable as a desktop computer, a laptop computer, a mobile device (e.g., assuming a handheld configuration such as a tablet or mobile phone), and so forth. Thus, a computing system ranges from a full-resource device with substantial memory and processor resources (e.g., personal computers and game consoles) to a low-resource device with limited memory and/or processing resources, e.g., mobile devices. Additionally, although separate, individual computing systems are shown and described in instances in the following discussion, each computing system is also representative of a plurality of different devices, such as multiple servers utilized by a business to perform operations “over the cloud” and as further described in relation to FIG. 7.

The data system 102 includes a manager module 108 implemented using hardware and software resources (e.g., a processing device and computer-readable storage medium) of the data system 102 to support one or more data reporting services 110. The data reporting services 110 are made available remotely via network 106 to computing systems (e.g., computing device 104) to enable querying of data sets maintained by database 112.

Although, in this illustrated example, the database 112 is maintained locally at the data system 102, in other examples, the computing device 104 includes the database 112 to maintain the data set (or a subset thereof) locally at the computing device 104. When the database 112 is maintained locally at the computing device 104, aspects of the data system 102 (e.g., the manager module 108, the data reporting services 110, the database 112) are integrated within the computing device 104 to enable hardware and software resources on the computing device 104 to access the data set via a query 114.

The data reporting services 110 are scalable through implementation by the hardware and software resources of the data system 102 to support a variety of functionalities, including data accessibility, data verification, real-time data processing, data analytics, and so forth via queries 114. Examples of the data reporting services 110 include a subscription service, user subscription profiles, customer support data, software community data, history data, update data, event history data, a data aggregation service, a data storage service, a data management service, a data analytics service, a project management service, a business management service, an accounting service, and so on.

Accordingly, in the illustrated example, access from the computing device 104 to the data reporting services 110 is utilized by a support system 116 of the computing device 104. A virtual assistant module 118 (e.g., application, browser, network-enabled application, chatbot, and so on) of the support system 116 accesses the database 112 using the one or more data reporting services 110. The virtual assistant module 118, for instance, causes the computing device 104 to send a query 114 over the network 106 to an interface with the manager module 108 when the data reporting services 110 are implemented remotely. In another example, when the data reporting services 110 are implemented locally, the virtual assistant module 118 causes the computing device 104 to input the query 114 directly within the manager module 108.

The data reporting services 110 are configured to perform a function based on the query 114, such as manipulate data (e.g., insert, update, or delate data within the database 112) or manage database structure (e.g., create, alter, or drop tables, database objects, or databases within the database 112). A result generated by the data reporting services 110 based on querying the database 112 is output from the manager module 108. In one example, the result is output to the computing device 104 via the network 106. When the data reporting services 110 are implemented locally on the computing device 104, the manager module 108 outputs the result directly to the support system 116 or the virtual assistant module 118, such as over an internal communication channel of the support system 116.

The virtual assistant module 118 is configurable to receive a user request as a natural language query (NLQ) 120 with a query intent 122. Based on the NLQ 120, the virtual assistant module 118 generates query results 124 and query explanations 126 (e.g., for display in a user interface 128 of a display device 130) from the support system 116. The virtual assistant module 118 handles customer interactions (e.g., NLQs 120) utilizing one or more machine-learning models (e.g., LLMs).

For example, the virtual assistant module 118 trains machine-learning models using semi-structured data for text-to-query or text-to-SQL translations to generate queries 114 from NLQs 120. For the text-to-query translations, the machine-learning model also uses sentiment analysis based on detected query intents 122 to create a query 114. The virtual assistant module 118 trains a second machine-learning model to receive queries 114 as input and generate query explanations 126 to describe the intent and actions of the queries 114 in natural language. The virtual assistant module 118 also provides validation with prediction assessment for matching NLQs 120 with query intents 122 and guardrails to add controls on user inputs and system outputs. The query explanations 126 include, for example, a description of query 114, a step-by-step explanation of how data reporting services 110 retrieve query result 124, and inline comments on query 114.

As illustrated, the user interface 128 is displayed on a display device 130 of the computing device 104, and within the user interface 128, the NLQ 120, the query results 124, and the query explanations 126 are displayed as multimedia information, e.g., textual responses, graphics, and/or a combination thereof. The user interface 128 is a graphical user interface in the illustrated example. In other examples, the user interface 128 is output as another type of user interface (e.g., an audible user interface through an audio output device) or a combination of multiple user interface types and output devices.

In one implementation, the query results 124 and query explanations 126 are provided as part of a chat interface. The chat interface provides a unified task-based interface with text and audio input to receive customers' NLQs 120 and provides query results 124 and query explanations 126. The virtual assistant module 118 determines a query intent 122 based on the NLQ 120, generates query 114 for database 112, and responds to the NLQ 120 with query results 124. The virtual assistant module 118 also uses query 114 to generate query explanations 126 that provide natural language descriptions of query 114 and a step-by-step explanation of the query process. In this way, the user confirms that the query 114 matches the query intent 122.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Virtual Assistance

The following discussion describes database-query AI virtual assistance techniques that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks.

Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are storable on a computer-readable storage medium that causes the hardware to perform the algorithm.

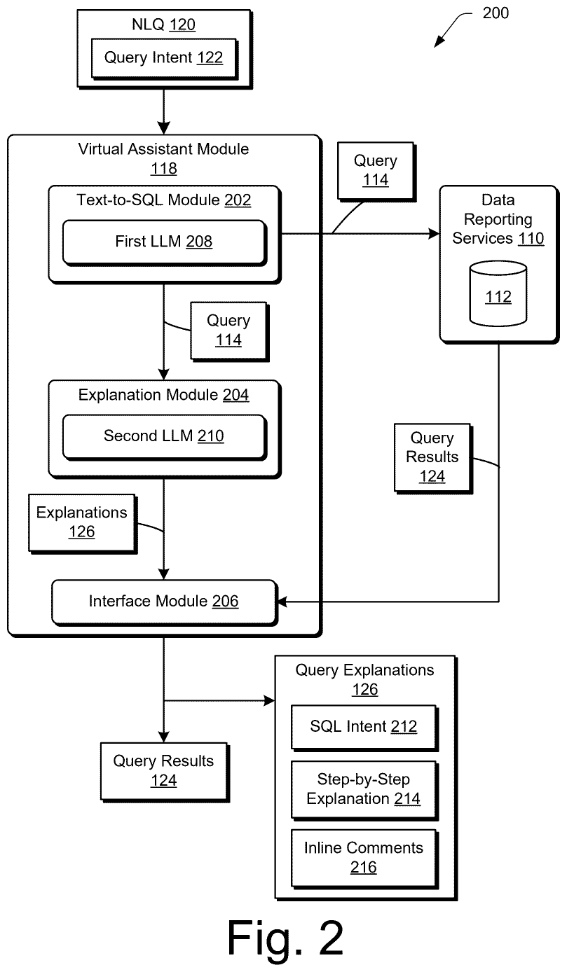

FIG. 2 depicts an example implementation 200 of a virtual assistant module 118 of FIG. 1 in greater detail as employing techniques to provide explanations of database queries as described herein. The virtual assistant module 118 includes a text-to-SQL module 202, an explanation module 204, and an interface module 206. The text-to-SQL module 202 uses a first large language model (LLM) 208 to generate the query 114 (e.g., in a SQL format) based on the NLQ 120 and the query intent 122 determined from the NLQ 120 and the general context of the user interaction. The explanation module 204 uses a second LLM 210 to generate query explanations 126 of the query 114 for display to the user. The interface module 206 collects the query results 124 and query explanations 126 and prepares their presentation or display to the user.

LLMs are machine-learning models designed to understand, generate, and interact with human language inputs at a large scale. These models are trained on vast amounts of text data using deep learning techniques (e.g., neural networks) to learn patterns, nuances, and the structure of language.

LLMs are configurable to perform a wide range of language-related tasks without being explicitly programmed for each one. These tasks include text generation, translation, summarization, question answering, sentiment analysis, and natural language processing. To train an LLM, the underlying machine-learning model is provided with training data that includes examples of text to train and retrain the model to predict the next word in a sequence. Over time, the model, once trained, is configured to generate text that is coherent and contextually relevant, configurable to mimic the style and content of the training data, and so forth. In this way, LLMs provide a foundational tool in artificial intelligence for understanding and generating human language, powering a wide range of applications from conversational agents to content creation tools, including caption writing.

To begin in this example, the virtual assistant module 118 receives the NLQ 120 with a query intent 122. The NLQ 120, for instance, represents a text message (e.g., a plain language request entered into a chat interface of the virtual assistant module 118), an audio message (e.g., a verbal request spoken by the user), a selection of one or more UI elements within a chat interface containing the NLQ 120, or a combination thereof. In one or more aspects, the NLQ 120 is received (e.g., via a chat interface) from a prompt interface to a first machine-learning model 208 of the text-to-SQL module 202.

Generally, the text-to-SQL module 202 uses the first LLM 208 to determine the query intent 122 from a context associated with the NLQ 120 and based on the NLQ and output the query 114 to the data reporting services 110. The text-to-SQL module 202, in one or more implementations, shares an interface with the first LLM 208 and infers the query intent 122 based on semantic machine-learning techniques applied to the NLQ 120. In another example, the text-to-SQL module 202 applies rule-based techniques to derive the query intent 122 or uses a combination of rule-based and machine-learning techniques to determine the query intent 122. Query intent 122 sets the stage for determining queries 114 (e.g., SQL queries) inferable from NLQs 120. By understanding query intent 122, the virtual assistant module 118 returns results based on the NLQ 120, which improves efficiency in customer interactions with the virtual assistant module 118 and in analyzing data sets.

The data reporting services 110 uses the query 114 to obtain the query results 124 from the database 112. The query results 124 are then provided to the interface module 206. The query 114 is also output to the explanation module 204. The input to the explanation module 204 generally does not include the NLQ 120 or query intent 122 to not influence the second LLM 210.

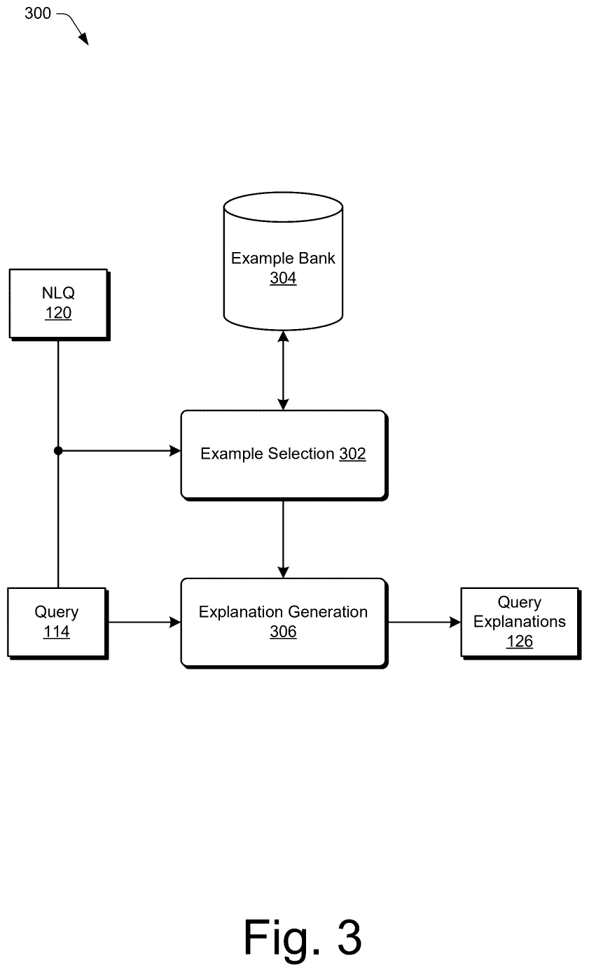

The explanation module 204 uses the second LLM 210 to generate the query explanations 126 of the query 114. In one implementation, the explanation module 204 uses an in-context learning approach by appending a few examples to the prompt to the second LLM 210 to enable better query explanations 126, which is described in greater detail with respect to FIG. 3 below. In another implementation, the explanation module 204 uses a fine-tuning-based approach by using specially designed training data tailored to the explanation task. The query explanations 126 are then provided to the interface module 206.

The interface module 206 then presents the query results and/or query explanations 126 to the user (e.g., via a chat interface). In one implementation, the query explanations 126 are first provided to the user. Once the user approves or indicates that the query explanations 126 indicate the query 114 matches the query intent 122, the interface module 206 presents the query results 124. In another implementation, the query explanations 126 and query results 124 are presented together.

The query explanations 126 include an SQL intent 212, a step-by-step explanation 214, and inline comments 216. The SQL intent 212 provides a natural language explanation of the intent or purpose of the query 114. The step-by-step explanation 214 provides a plain, concise description of how the query results 124 are obtained to give the user an understanding of the query operations performed. The inline comments 216 provide detailed, technical descriptions of the query 114 to give technical users a more detailed understanding of the query operations. In one implementation, the interface module 206 initially provides the SQL intent 212 with a selectable option for the user to request the step-by-step explanation 214 and/or the inline comments 216. Because SQL intent 212 and step-by-step explanation 214 are provided in natural language, the user easily and readily ensures that query 114 matches the original intent of NLQ 120.

FIG. 3 depicts an example implementation 300 of an explanation module 204 of FIG. 2 in greater detail, employing techniques to explain database queries. In one implementation, the second LLM 210 is a trained LLM accessible via an application programming interface (API) call. The explanation module 204 utilizes an in-context learning framework to generate the query explanations 126 using the second LLM 210.

To begin, the explanation module 204 receives the query 114 (e.g., an SQL query) from the text-to-SQL module 202. The explanation module 204 also receives, from the data reporting services 110 or the text-to-SQL module 202, details of the relevant schema that identifies the table or database information used in the query 114 and the query results 124. The explanation module 204 then compiles detailed instructions for the second LLM 210 to generate each part of the query explanations 126.

As part of the detailed instructions, the explanation module 204 uses query 114 to perform example selection (block 302). For example, the prompt includes several relevant examples (e.g., up to ten examples) of input-output pairs to improve the generalizability of the response by the second LLM 210. In one implementation, the input-output pairs include example queries 114, schema, query results 124, and query explanations 126. Given a limited prompt context window for the second LLM 210, the chosen examples are selected as particularly relevant to the specific query 114.

To perform example selection (block 302), the explanation module 204 receives an inputs the NLQ 120 and the query 114. The explanation module 204 also accesses a set of example triplets in an example bank 304. Each example triplet includes a corresponding set of NLQ 120, query 114, and query explanations 126. In one implementation, the example bank 304 includes several hundred example triplets.

The explanation module 204 then constructs a N-dimensional vector embedding (with integer entries) of each query 114 in the example bank, with N being a positive integer. The explanation module 204 uses a fixed set of common query or SQL keywords (e.g., “where,” “join,” “group by,” “order by,” “having,” “limit,” “like,” “distinct,” “intersect,” “union,” “except,” “and,” “or,” “asc,” “desc,” and “lower”) and the table names present in the schema. The dimensionality of the vector embedding is based on the fixed set of keywords and table names. Each position in the vector embedding is the number of times the entity appears in the query 114 (with case not being considered). For example, the first index in the constructed vector is the number of times the word “where” appears in the query 114.

For the input query 114, the explanation module 204 obtains several (e.g., two) top examples in the example bank 304 by ranking the vector embeddings of each example triplet in terms of cosine similarity with the query 114. The average of the vectors for the top examples is computed and subtracted from the embedding vector of the input query 114. The modified input embedding vector represents the vector embedding of the template that is not covered by the chosen top examples. Each negative entry in the modified input embedding vector is set to a zero value.

The explanation module 204 then obtains the top examples in the example bank 304 by ranking the vector embeddings with the modified input embedding vector. The process of obtaining a modified input embedding vector and selecting the top examples in the example bank 304 is repeated until the modified embedding template is an all-zero vector. The explanation module 204 then selects a subset of the remaining example triplets in the example bank 304 by extracting the unique example triplets (e.g., those not previously chosen in the iterative process) that are closest in cosine similarity to the original vector embedding of the input query 114.

The explanation module uses the extracted example triplets to generate a prompt for explanation generation (block 306) by the second LLM 210. The prompt instructions identify the components of the query explanations 126 and provide detailed instructions for each. For example, the second LLM 210 is instructed to format the query results 124 in a visibly appealing manner in a specific language (e.g., English) and for presentation to the user. The SQL intent 212 is to be a short summary of the intent of the query 114 in a specific language. The step-by-step explanation 214 is to be a detailed step-by-step breakdown of what the query 114 is trying to do and how this is accomplished in the database 112. The inline comments 216 are to be formatted visibly appealingly and partitioned into small components, each with a one-line explanation. The instructions note that the inline comments 216 are directed toward somewhat technically equipped users for improved interaction. In other implementations, the instructions provided by the explanation module 204 to the second LLM 210 include fewer, additional, or different details.

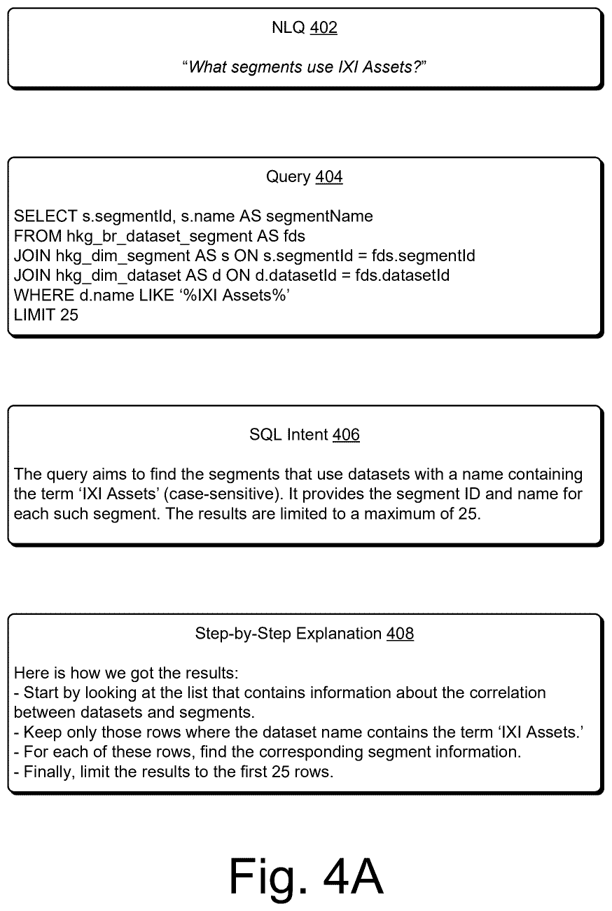

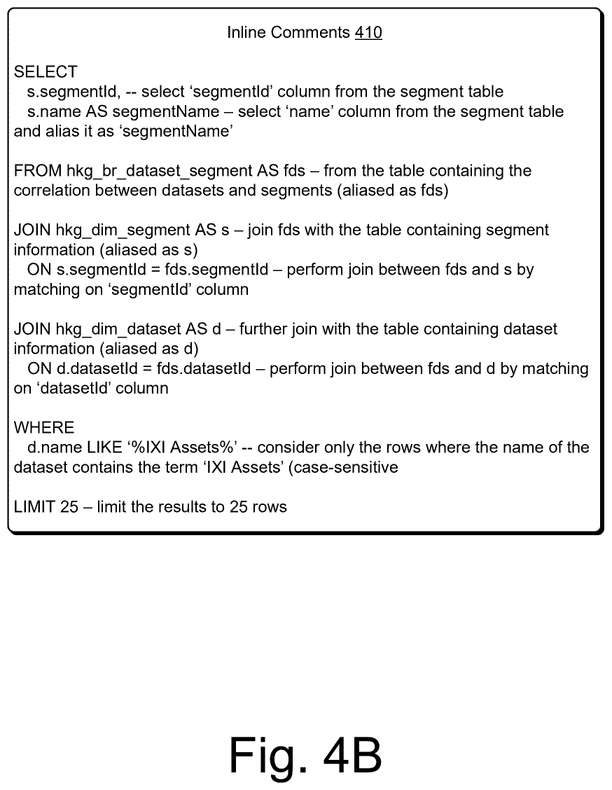

FIGS. 4A and 4B illustrate an example query and explanations generated from a NLQ using an AI virtual assistant that provides explanations of database queries as described herein.

In this example, the user interacts with a chat interface of the virtual assistant module 118 within a spreadsheet or database application to submit a NLQ 402: “What segments use IXI Assets?” In response to the NLQ 402, the first LLM 208 of the text-to-SQL module 202 generates a query 404:

SELECT s.segmentId, s.name AS segmentName
FROM hkg_br_dataset_segment AS fds
JOIN hkg_dim_segment AS s ON s.segmentId = fds.segmentId
JOIN hkg_dim_dataset AS d ON d.datasetId = fds.datasetId
WHERE d.name LIKE ‘%IXI Assets%’
LIMIT 25

Using the query 404, the explanation module 204 uses the second LLM 210 to generate query explanations 126 to provide context to the user for the query results 124 and how those results were obtained. For example, the query explanations 126 include an SQL intent 406, a step-by-step explanation 408, and inline comments 410. The SQL intent 406 provides a short purpose statement for the query 404 for the user to verify that this intent matches their intent associated with the NLQ 402. In this example, the SQL intent 406 states: “The query aims to find the segments that use datasets with a name containing the term ‘IXI Assets’ (case-sensitive). It provides the segment ID and name for each such segment. The results are limited to a maximum of 25.”

The chat interface also provides the step-by-step explanation 408 to give the user additional context for the query results:
Here is how we got the results:
   Start by looking at the list that contains information about the correlation between datasets and segments.
   Keep only those rows where the dataset name contains the term ‘IXI Assets.’
   For each of these rows, find the corresponding segment information.
   Finally, limit the results to the first 25 rows.

For technical users, the virtual assistant module 118 also provides the following inline comments 410:

```
SELECT
  s.segmentId, -- select ‘segmentId’ column from the segment table
  s.name AS segmentName - select ‘name’ column from the
segment table and alias it as ‘segmentName’
FROM hkg_br_dataset_segment AS fds - from the table containing the
correlation between datasets and segments (aliased as fds)
JOIN hkg_dim_segment AS s - join fds with the table containing
segment information (aliased as s)
  ON s.segmentId = fds.segmentId - perform join between fds and s by
matching on ‘segmentId’ column
JOIN hkg_dim_dataset AS d - further join with the table containing
dataset information (aliased as d)
  ON d.datasetId = fds.datasetId - perform join between fds and d by
matching on ‘datasetId’ column
WHERE
  d.name LIKE ‘%IXI Assets%’ -- consider only the rows where the
name of the dataset contains the term ‘IXI Assets' (case-sensitive
LIMIT 25 - limit the results to 25 rows
```

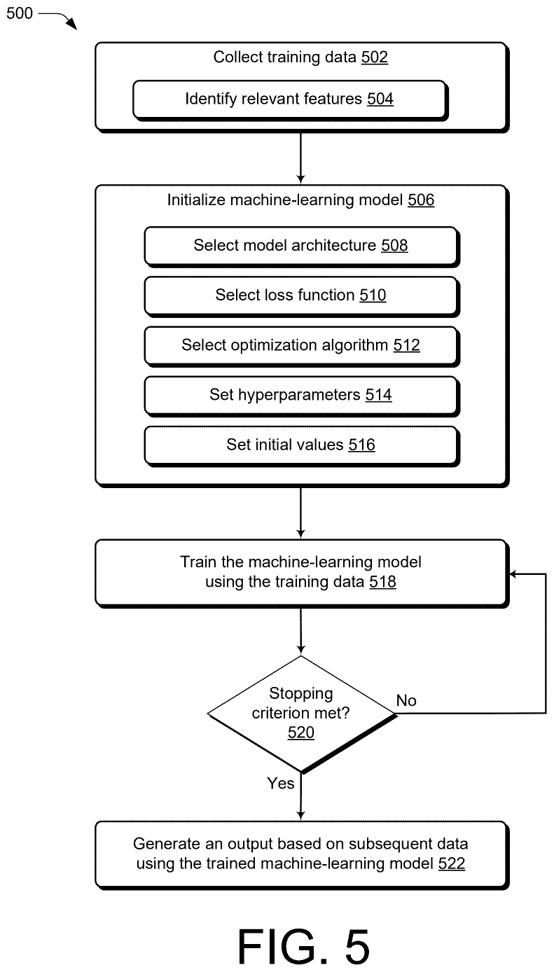

FIG. 5 is a flow diagram depicting an algorithm as a step-by-step procedure 500 in an example implementation of operations performable for training a machine-learning model of the virtual assistant module 118 of FIG. 1. The procedure 500 provides one or more examples of generating training data, use of the training data to train a machine-learning model, and use of the trained machine-learning model to perform a task.

To begin in this example, the support system 116 or virtual assistant module 118 collects training data (block 502) to be used as a basis to train a machine-learning model (e.g., the first LLM 208 and the second LLM 210), i.e., which defines what is being modeled. The training data is collectible by the support system 116 from a variety of sources. Examples of training data sources include public datasets, service provider system platforms that expose application programming interfaces (e.g., social media platforms), user data collection systems (e.g., digital surveys and online crowdsourcing systems), and so forth. Training data collection also includes data augmentation and synthetic data generation techniques to expand and diversify available training data, balancing techniques to balance several positive and negative examples, and so forth.

The support system 116 is also configurable to identify relevant features (block 504) to a task type for which the machine-learning model is to be trained. Task examples include classification, natural language processing, generative artificial intelligence, recommendation engines, reinforcement learning, clustering, and so forth. To do so, the support system 116 collects the training data based on the identified features and/or filters the training data based on the identified features after collection. The training data is then utilized to train a machine-learning model.

In order to train the machine-learning model in the illustrated example, the machine-learning model is first initialized (block 506). Initialization of the machine-learning model includes selecting a model architecture (block 508) to be trained. Examples of model architectures include large language models (LLMs), neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model uses an LLM to understand, generate, and interact with human language inputs (e.g., NLQ 120). These machine-learning models are trained on vast amounts of text data using deep learning techniques (e.g., neural networks) to learn patterns, nuances, and the structure of language.

As described above, LLMs are configurable to perform a wide range of language-related tasks without being explicitly programmed for each one. To train the LLM, the underlying machine-learning model is provided with training data that includes examples of text to train and retrain the model to predict the next word in a sequence. Over time, the model, once trained, is configured to generate text that is coherent, contextually relevant, and mimics the style and content of the training data, and so forth.

A loss function is also selected (block 510). The loss function is utilized to measure a difference between an output of the machine-learning model (i.e., predictions) and target values (e.g., as expressed by the training data) to be used to train the machine-learning model. Additionally, an optimization algorithm is selected (block 512) to be used in conjunction with the loss function to optimize parameters of the machine-learning model during training, examples of which include gradient descent, stochastic gradient descent (SGD), and so forth.

Initialization of the machine-learning model further includes setting hyperparameters and initial values of the machine-learning model (blocks 514 and 516), examples of which include initializing weights and biases of nodes to improve efficiency in training and computational resource consumption as part of training. Hyperparameters are also set to control the training of the machine learning model, examples include regularization parameters, model parameters (e.g., a number of layers in a neural network), learning rate, batch sizes selected from the training data, and so on. The hyperparameters are set using various techniques, including the use of a randomization technique, the use of heuristics learned from other training scenarios, and so forth.

The machine-learning model is then trained using the training data (block 518) by the support system 116. A machine-learning model refers to a computer representation that is tunable (e.g., trained and retrained) based on inputs of the training data to approximate unknown functions. In particular, the term machine-learning model includes a model that utilizes algorithms (e.g., using the model architectures described above) to learn from and make predictions on known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 520), which is used to validate the model. The stopping criterion is usable to reduce the overfitting of the machine-learning model, reduce computational resource consumption, and promote the ability of the machine-learning model to address previously unseen data (e.g., data not included specifically as an example in the training data). Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 520), procedure 500 continues training of the machine-learning model using the training data (block 518) in this example.

If the stopping criterion is met (“yes” from decision block 520), the trained machine-learning model is then utilized to generate an output based on subsequent data (block 522) (e.g., to generate the query results 124 or query explanations 126). The trained machine-learning model, for instance, is trained to perform a task as described above and therefore once trained is configured to perform that task based on subsequent data received as input and processed by the machine-learning model.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedure

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5.

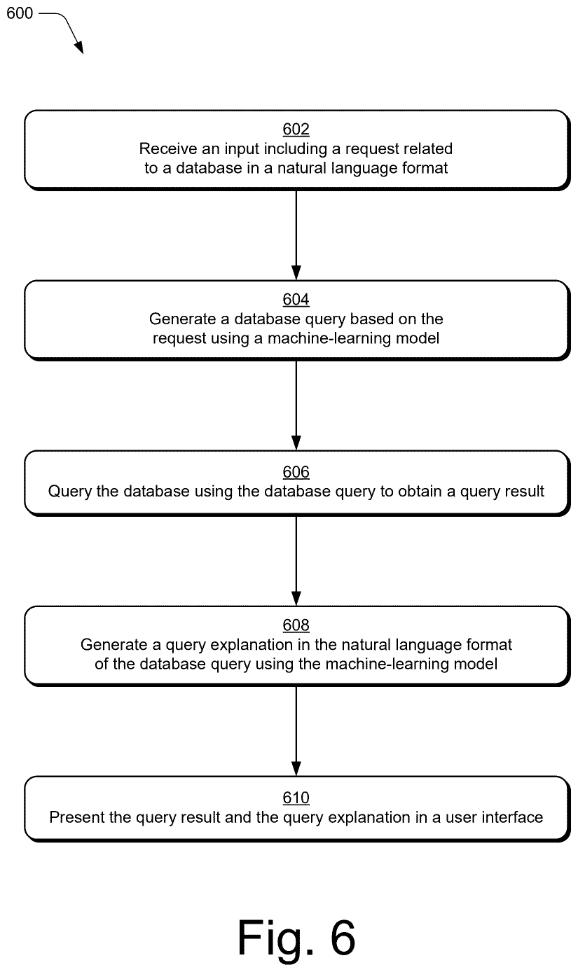

FIG. 6 is a flow diagram depicting a procedure in an example implementation for providing explanations of database queries by an AI virtual assistant as described herein. To begin, a processing device receives an input including a request in a natural language format related to a database (block 602). For example, the input includes the NLQ 120 with query intent 122 and is received from or via a prompt interface (e.g., a chat interface) of the virtual assistant module 118. The chat interface receives the NLQ as a text or audio message with a particular query intent 122. The request includes an instruction to create, alter, retrieve, delete, manage, or manipulate the database 112 or data therein.

A machine-learning model generates a database query based on the request (block 604). For example, the machine-learning model includes the first LLM 208 generates the query 114. In generating the query 114, the first LLM 208 uses a context of the NLQ 120 to infer the query intent 122.

The processing device queries the database using the database query to obtain a query result (block 606). For example, the data reporting services 110 use the query 114 to generate the query results 124 from the database 112.

The machine-learning model then generates an explanation of the database query in the natural language format (block 608). The query explanation includes a summary of an intent of the database query in the natural language format, a step-by-step explanation of execution of the database query to obtain the query result, and/or inline comments that provide a technical description of portions of the database query and the execution of the database query. For example, the query 114 is in a structured query language (SQL) format.

The machine-learning model includes the second LLM 210 that generates the query explanation without using the NLQ 120 as an inference input. The inference input to the second LLM 210 includes the query 114, instructions to generate the query explanations 126, and at least one example input-output pair to provide context to the second LLM 210 for generating the query explanations 126. Each example input-output pair, which is selected from an example database with multiple example input-output pairs based on the NLQ 120 and the query 114, includes an example database query, an example schema for the example database query, and corresponding query explanations for the example database query.

The processing device then presents the query result and the query explanation for display in a user interface (block 610). For example, the query results 124 and query query explanations 126 of the virtual assistant module 118 are provided as a text response in a natural language format within a chat interface. In one implementation, the virtual assistant module 118 prompts the user via the chat interface to approve the query 114 based on the query query explanations 126. In response to the user approving the query 114, the virtual assistant module 118 presents the query results 124. In response to the user not approving the query 114, the virtual assistant module 118 prompts the user to refine the NLQ to generate an updated query 114.

### Example System and Device

FIG. 7 illustrates an example system 700 that includes an example computing device that is representative of one or more computing systems and/or devices that are usable to implement the various techniques described herein. This is illustrated through inclusion of the virtual assistant module 118. The computing device 702 includes, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that are configured as processors, functional blocks, and so forth. This includes example implementations in hardware as an application specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. The memory/storage 712 represents memory/storage capacity associated with one or more computer-readable media. In one example, the memory/storage 712 includes volatile media (such as random access memory (RAM)) and/or nonvolatile media (such as read only memory (ROM), Flash memory, optical disks, magnetic disks, and so forth). In another example, the memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction. In other implementations, the computing device 702 is also configurable to support machine-to-machine (M2M) interactions for which application programmable interfaces (APIs) are provided by the system 700.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 710. For example, the computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supportable by various configurations of the computing device 702 and are not limited to the specific examples of the techniques described herein. This functionality is also implementable entirely or partially through use of a distributed system, such as over a “cloud” 714 as described below.

The cloud 714 includes and/or is representative of a platform 716 for resources 718. The platform 716 abstracts underlying functionality of hardware (e.g., servers) and software resources of the cloud 714. For example, the resources 718 include applications and/or data that are utilized while computer processing is executed on servers that are remote from the computing device 702. In some examples, the resources 718 also include services provided over the Internet and/or through a subscriber network, such as a cellular or Wi-Fi network.

The platform 716 abstracts the resources 718 and functions to connect the computing device 702 with other computing devices. In some examples, the platform 716 also serves to abstract scaling of resources to provide a corresponding level of scale to encountered demand for the resources that are implemented via the platform. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, an input including a request in a natural language format related to a database, the request including an instruction to create, alter, retrieve, delete, manage, or manipulate the database or data in the database;
generating, by a machine-learning model, a database query based on the request;
querying, by the processing device, the database using the database query to obtain a query result;
generating, by the machine-learning model, a query explanation of the database query in the natural language format; and
presenting, by the processing device, the query result and the query explanation in a user interface.

2. The method of claim 1, wherein the machine-learning model includes:
a first large language model (LLM) that generates the database query based on the request; and
a second LLM that generates, based on the database query, the query explanation in the natural language format.

3. The method of claim 2, the method further comprising:
identifying, by the first LLM and based on a context of the request, an intent on the input, wherein the intent is used by the first LLM to generate the database query.

4. The method of claim 2, wherein the second LLM generates the query explanation without using the request as an inference input.

5. The method of claim 4, wherein the inference input includes:
the database query generated by the first LLM;
instructions to generate the query explanation; and
at least one example input-output pair to provide context to the second LLM for generating the query explanation, each example input-output pair including an example database query, an example schema for the example database query, and a corresponding query explanation.

6. The method of claim 5, wherein the at least one example input-output pair is selected from an example database that includes multiple example input-output pairs based on the request in the natural language format and the database query.

7. The method of claim 1, wherein the query explanation includes:
a summary of an intent of the database query in the natural language format; or
a step-by-step explanation of execution of the database query by the processing device to obtain the query result.

8. The method of claim 7, wherein the query explanation further includes:
the database query; and
inline comments providing a technical description of portions of the database query and the execution of the database query by the processing device.

9. The method of claim 1, wherein the database query is in a structured query language (SQL) format.

10. The method of claim 1, wherein the input is received from a prompt interface to the machine-learning model that includes a chat interface configured to receive the input as a text message or an audio message and provide the query result and the query explanation as text responses in the natural language format.

11. The method of claim 10 further comprising:
prompting, based on the query explanation, a user to approve the database query, the query explanation being presented before the query result; and
in response to the user not approving the database query, prompting the user to refine the input to generate an updated database query.

12. The method of claim 11 further comprising:
in response to the user approving the database query, presenting the query result in the chat interface.

13. A system comprising:
a memory component storing a database; and
a processing device communicatively coupled to the memory component, the processing device configured to:
receive an input including a request in a natural language format related to the database, the request including an instruction to create, alter, retrieve, delete, manage, or manipulate the database or data in the database;
generate, by a first large language model (LLM), a database query based on the request, the database query being in a structured query language (SQL) format;
query, using the database query, the database to obtain a query result;
generate, by a second LLM, a query explanation of the database query in the natural language format; and
presenting the query result and the query explanation in a user interface.

14. The system of claim 13, wherein the second LLM generates the query explanation without using the request as an inference input.

15. The system of claim 14, wherein the inference input includes:
the database query generated by the first LLM;
instructions to generate the query explanation; and
at least one example input-output pair to provide context to the second LLM for generating the query explanation, each example input-output pair including an example database query, an example schema for the example database query, and a corresponding query explanation, the at least one example input-output pair being selected from an example database that includes multiple example input-output pairs based on the request in the natural language format and the database query.

16. The system of claim 13, wherein the query explanation includes at least two of:
a summary of an intent of the database query in the natural language format;
a step-by-step explanation of execution of the database query by the processing device to obtain the query result; or
inline comments providing a technical description of portions of the database query and the execution of the database query by the processing device.

17. The system of claim 13, wherein the processing device is further configured to:
prompt, based on the query explanation, a user to approve the database query, the query explanation being presented before the query result; and
in response to the user not approving the database query, prompt the user to refine the input to generate an updated database query; or
in response to the user approving the database query, presenting the query result in a chat interface.

18. A non-transitory computer-readable medium storing executable instructions, which when executed by a processing device, cause the processing device to perform operations comprising:
receiving an input including a request in a natural language format related to a database, the request including an instruction to create, alter, retrieve, delete, manage, or manipulate the database or data in the database;
generating, by a machine-learning model, a database query based on the request;
querying the database using the database query to obtain a query result;
generating, by the machine-learning model, a query explanation of the database query in the natural language format; and
presenting the query result and the query explanation in a user interface.

19. The non-transitory computer-readable medium of claim 18, wherein the database query is in a structured query language (SQL) format and the query explanation includes at least two of:
a summary of an intent of the database query in the natural language format;
a step-by-step explanation of execution of the database query by the processing device to obtain the query result; or
inline comments providing a technical description of portions of the database query and the execution of the database query by the processing device.

20. The non-transitory computer-readable medium of claim 18, wherein the machine-learning model includes:
a first large language model (LLM) that generates the database query based on the request; and
a second LLM that generates, based on the database query, the query explanation without using the request as an inference input.
